(19) United States
(12) Patent Application Publication
(10) Pub. No.: US 2014/0125940 A1
(43) Pub. Date: May 8, 2014

(54) Eyeglass Assembly

(71) Applicant: York Tsai, New Taipai City (TW)

(72) Inventor: York Tsai, New Taipai City (TW)

(21) Appl. No.: 13/949,280

(22) Filed: Jul. 24, 2013

(30) Foreign Application Priority Data
Nov. 7, 2012 (TW) 101149349

(51) Int. Cl. G02C 1/00

(52) U.S. Cl. CPC G02C 1/10
USPC 351/105

(57) ABSTRACT

An eyeglass assembly includes: a frame having a transverse segment and first segments that cooperate with the transverse segment to form two generally L-shaped structures; a lens unit having an upper lens edge and first lens edges and formed with two engaging recesses, the lens unit being inserted into the frame so that the lens unit is restricted by the generally L-shaped structures; and a pair of temple arms, each of which has an engaging tongue. The engaging tongues engage the respective engaging recesses when the temple arms are disposed at an unfolded position, and are disengaged from the respective engaging recesses when the temple arms are disposed at a folded position.

### CROSS-REFERENCE TO RELATED APPLICATION

This application claims priority of Taiwanese application no. 101149349, filed on Nov. 7, 2012.

### BACKGROUND OF THE INVENTION

1. Field of the Invention

This invention relates to an eyeglass assembly, more particularly to an eyeglass assembly including a lens and a temple arm that releasably engages the lens.

2. Description of the Related Art

Referring to FIGS. 1 and 2, U.S. Pat. No. 5,898,469 discloses a conventional eyeglass assembly 1 that includes a frame 11, a mono-lens 12, and a pair of temple arms 13. The frame 11 defines a lens-receiving groove 111, and has two opposite end portions that define two temple-receiving recesses 112. Each of the temple arms 13 has an engaging section 131 and a main temple section 132 extending from and pivoted to the engaging section 131. The engaging section 131 of each of the temple arms 13 extends into a respective one of the temple-receiving recesses 112, and is pivoted to a respective one of the end portions of the frame through a pivot screw 14. The mono-lens 12 is detachably inserted into the lens-receiving groove 111, and has two opposite sides that are formed with two engaging recesses 121, respectively. The engaging section 131 of each of the temple arms 13 is pivotable about the pivot screw 14 between an unfolded position (see FIG. 2), in which the engaging section 131 engages a respective one of the engaging recesses 121 so as to position the mono-lens 12 on the frame 11, and a folded position (not shown), in which the engaging section 131 is disengaged from the respective one of the engaging recesses 121 so as to permit detachment of the mono-lens 12 from the frame 11. Since the mono-lens 12 of the conventional eyeglass assembly 1 is held on the frame 11 only through engagement between the engaging sections 131 and the engaging recesses 121, the mono-lens 12 has a tending to swing when the wearer jogs or runs.

### SUMMARY OF THE INVENTION

Therefore, an object of the present invention is to provide an eyeglass assembly that can overcome the aforesaid drawback associated with the prior art.

According to the present invention, there is provided an eyeglass assembly that comprises: a frame having a transverse segment and two opposite first segments that extend downwardly from and cooperate with the transverse segment to form two generally L-shaped structures, respectively, the transverse segment defining a transverse groove, each of the first segments defining a first groove that is in spatial communication with the transverse groove; a lens unit having an upper lens edge and two opposite first lens edges and formed with two engaging recesses, the upper lens edge being detachably inserted into the transverse groove, the first lens edges being detachably and respectively inserted into the first grooves in the first segments so that the lens unit is restricted by the generally L-shaped structures; and a pair of temple arms, each of which has an end portion that is pivoted to the frame, and an engaging tongue protruding from the end portion. Each of the temple arms is pivot able relative to the frame between an unfolded position and a folded position. The engaging tongue of each of the temple arms engages a respective one of the engaging recesses when the temple arms are disposed at the unfolded position, and is disengaged from the respective one of the engaging recesses when the temple arms are disposed at the folded position.

### BRIEF DESCRIPTION OF THE DRAWINGS

In drawings which illustrate embodiments of the invention,

FIG. 1 is an exploded perspective view of a conventional eyeglass assembly;

FIG. 2 is a fragmentary schematic side view of the conventional eyeglass assembly;

FIG. 3 is an exploded perspective view of the first preferred embodiment of an eyeglass assembly according to the present invention;

FIG. 4 is an assembled perspective view of the first preferred embodiment;

FIG. 5 is a partly sectional view of the first preferred embodiment;

FIG. 6 is a perspective view illustrating how a lens unit is detached from a frame of the first preferred embodiment;

FIG. 7 is a perspective view of the second preferred embodiment of the eyeglass assembly according to the present invention;

FIG. 8 is an exploded perspective view of the third preferred embodiment of the eyeglass assembly according to the present invention;

FIG. 9 is an assembled perspective view of the third preferred embodiment;

FIG. 10 is a perspective view of the fourth preferred embodiment of the eyeglass assembly according to the present invention, illustrating a state where a lens is detached from a frame;

FIG. 11 is a top view of the fourth preferred embodiment illustrating a state (with a frame being cut away for better illustration) where one temple arm is disposed at a non-fully folded position while another temple arm is disposed at an unfolded position; and

FIG. 12 is a top view of the fourth preferred embodiment illustrating another state (with the frame being cut away for better illustration) where said one temple arm is disposed at a fully folded position while said another temple arm is disposed at the unfolded position.

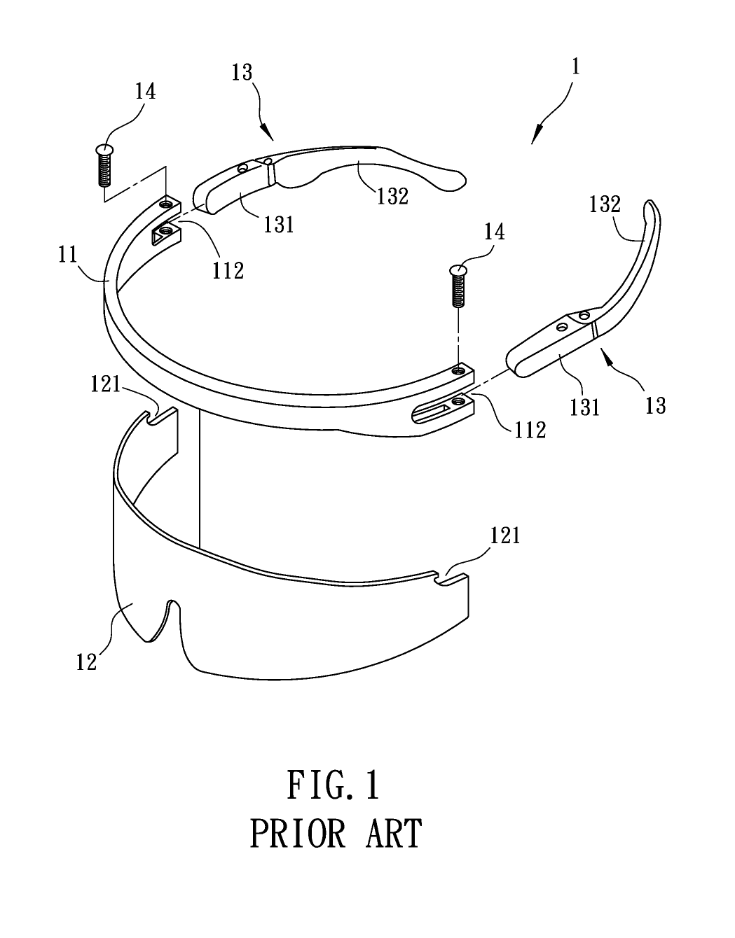

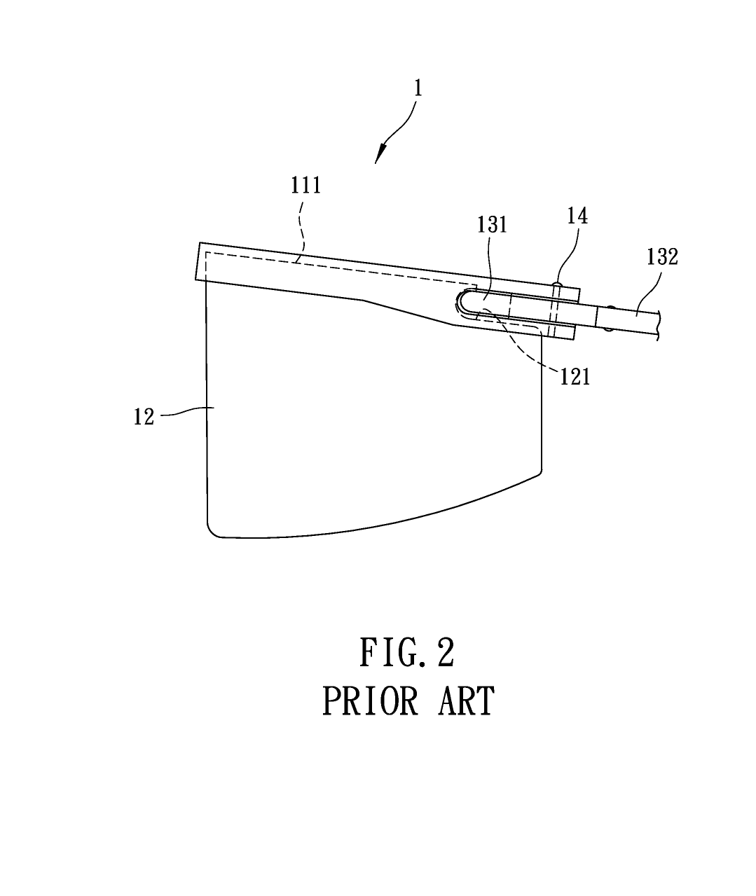

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

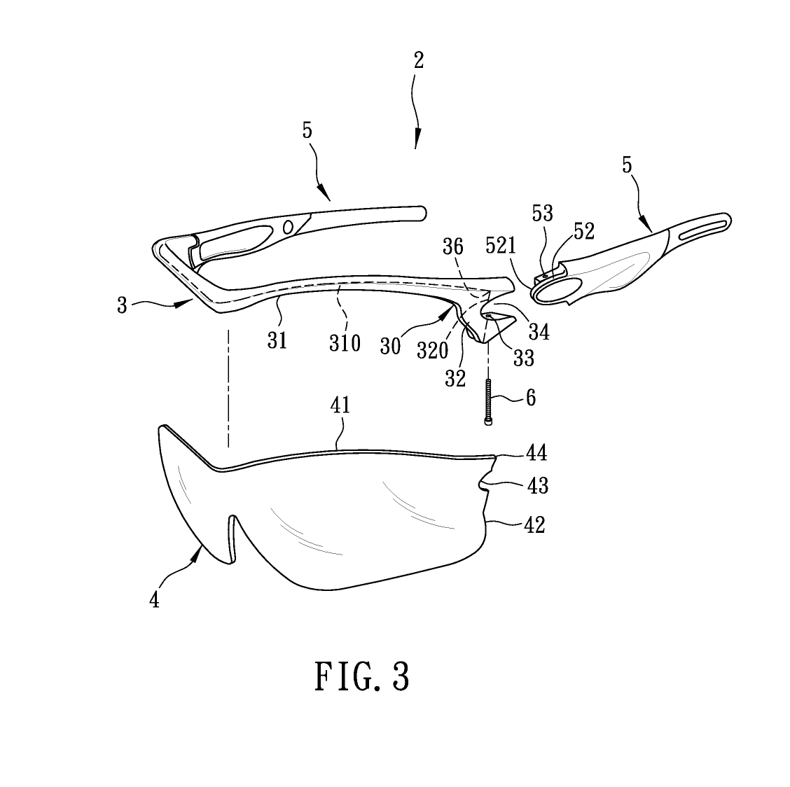

FIGS. 3 to 6 illustrate the first preferred embodiment of a lens-quick-release eyeglass assembly 2 according to the present invention.

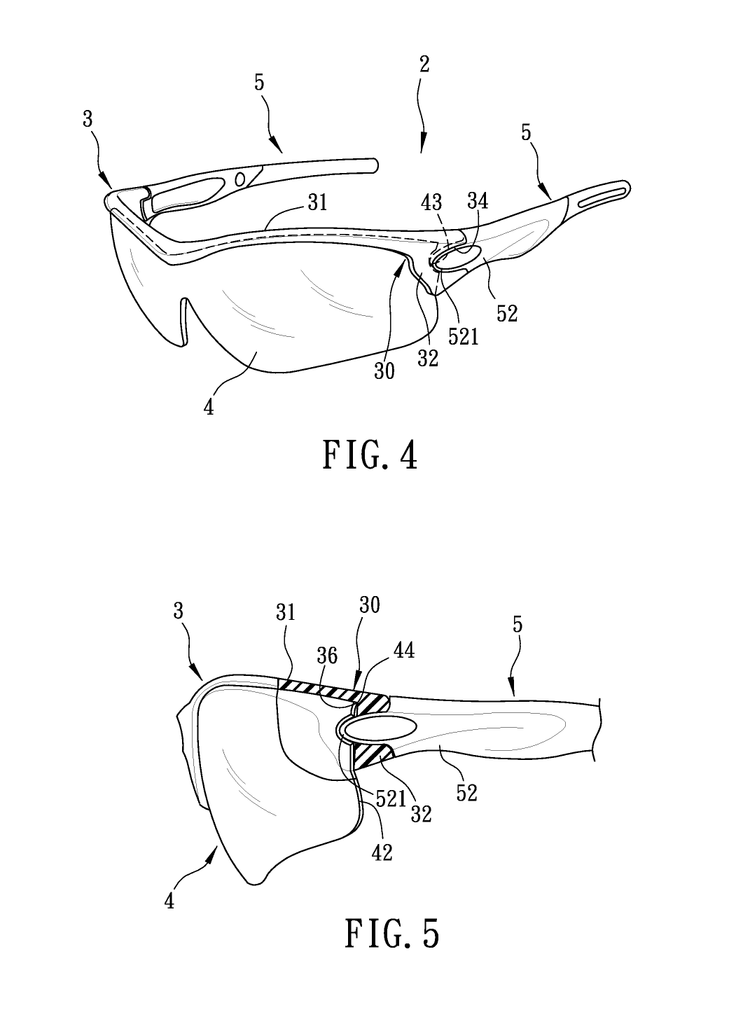

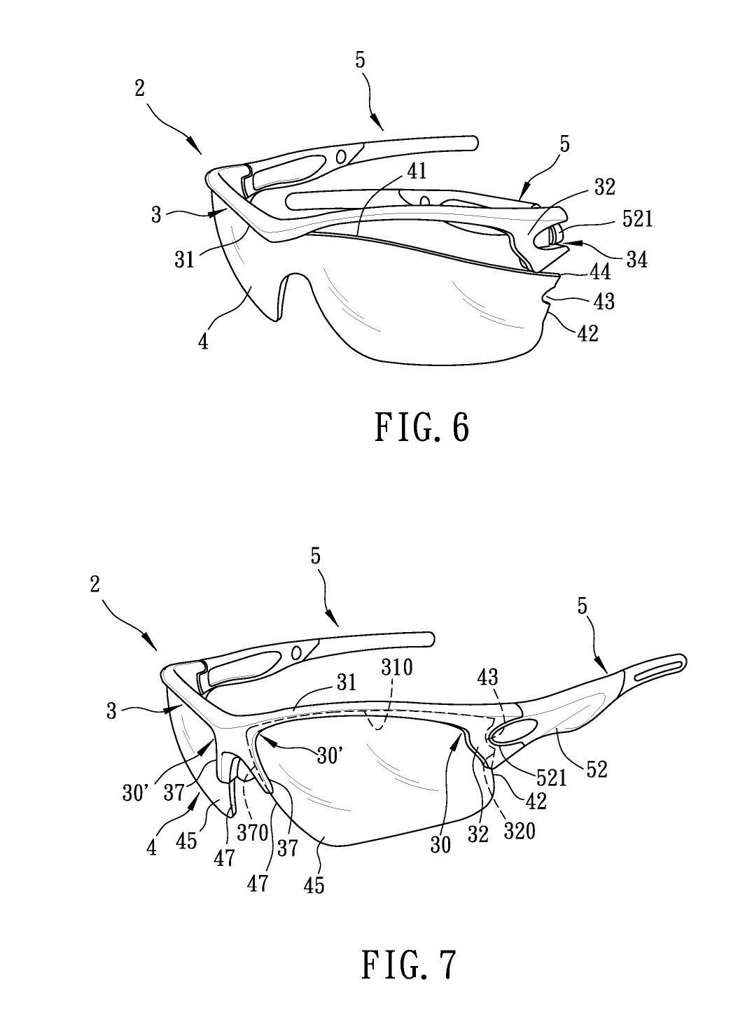

The eyeglass assembly 2 includes: a frame 3 having a transverse segment 31 and two opposite first segments 32 that extend downwardly from and cooperate with the transverse segment 31 to form two generally L-shaped structures 30, respectively, the transverse segment 31 defining a transverse groove 310, each of the first segments 32 defining a first groove 320 that is in spatial communication with the transverse groove 310; a lens unit 4 having an upper lens edge 41 and two opposite first lens edges 42 extending downwardly from the upper lens edge 41, the lens unit 4 being formed with two engaging recesses 43 at the first lens edges 42, respectively, the upper lens edge 41 being detachably inserted into the transverse groove 310, the first lens edges 42 being detachably and respectively inserted into the first grooves 320 in the first segments 32 so that the lens unit 4 is restricted by the generally L-shaped structures 30; two pivot screws 6; and a pair of temple arms 5, each of which has an end portion 52 that is pivoted to the frame 3 through a respective one of the pivot screws 6, and a first engaging tongue 521 protruding from the end portion 52. Each of the temple arms 5 is pivotable relative to the frame 3 between an unfolded position (see FIGS. 4 and 5) and a first folded position (see FIG. 6). The first engaging tongue 521 of each of the temple arms 5 engages a respective one of the engaging recesses 43 when the temple arms 5 are disposed at the unfolded position so as to position the lens unit 4 on the frame 3, and is disengaged from the respective one of the engaging recesses 43 when the temple arms 5 are disposed at the first folded position so as to permit detachment of the lens unit 4 from the frame 3.

In this embodiment, each of the first segments 32 further defines a temple-receiving recess 34 that is in spatial communication with a respective one of the first grooves 320. The first engaging tongue 521 of each of the temple arms 5 is disposed within the temple-receiving recess 34 in a respective one of the first segments 32 when the temple arms 5 are disposed at the unfolded position, and protrudes outwardly of the temple-receiving recess 34 in the respective one of the first segments 32 when the temple arms 5 are disposed at the first folded position. Each of the first segments 32 is formed with a screw hole 33 that is disposed outwardly of the temple-receiving recess 34. The end portion 52 of each of the temple arms 5 is formed with a screw hole 53. Each of the pivot screws 6 is disposed outwardly of the temple-receiving recess 34 in a respective one of the first segments 32. Each of the pivot screws 6 extends through the screw hole 53 in the end portion 52 of a respective one of the temple arms 5 and the screw hole 33 in the respective one of the first segments 32.

Each of the first lens edges 42 cooperates with the upper lens edge 41 to define an engaging corner therebetween. Each of the first grooves 320 cooperates with the transverse groove 310 to define a corner groove 36. The engaging corner 44 is fitted into the corner groove 36.

In this embodiment, each of the temple arms 5 is a single piece. The lens unit 4 has the form of a mono-lens.

FIG. 7 illustrates the second preferred embodiment of the eyeglass assembly 2 according to the present invention. The second preferred embodiment differs from the previous embodiment in that the frame 3 further has two second segments 37 which extend downwardly from and cooperate with the transverse segment 31 to form two second generally L-shaped structures 30′, which are disposed between the first segments 32, and which define two second grooves 370, respectively, and in that the lens unit 4 has a pair of lenses 45 and further has two second lens edges 47 which are detachably and respectively inserted into the second grooves 370. The second segments 37 join together at the transverse segment 31 and diverge therefrom so as to form a bridge structure that is adapted to be supported on the nose of a wearer. The second lens edges 47 are disposed adjacent to each other, and are disposed between and spaced apart from the first lens edges 42.

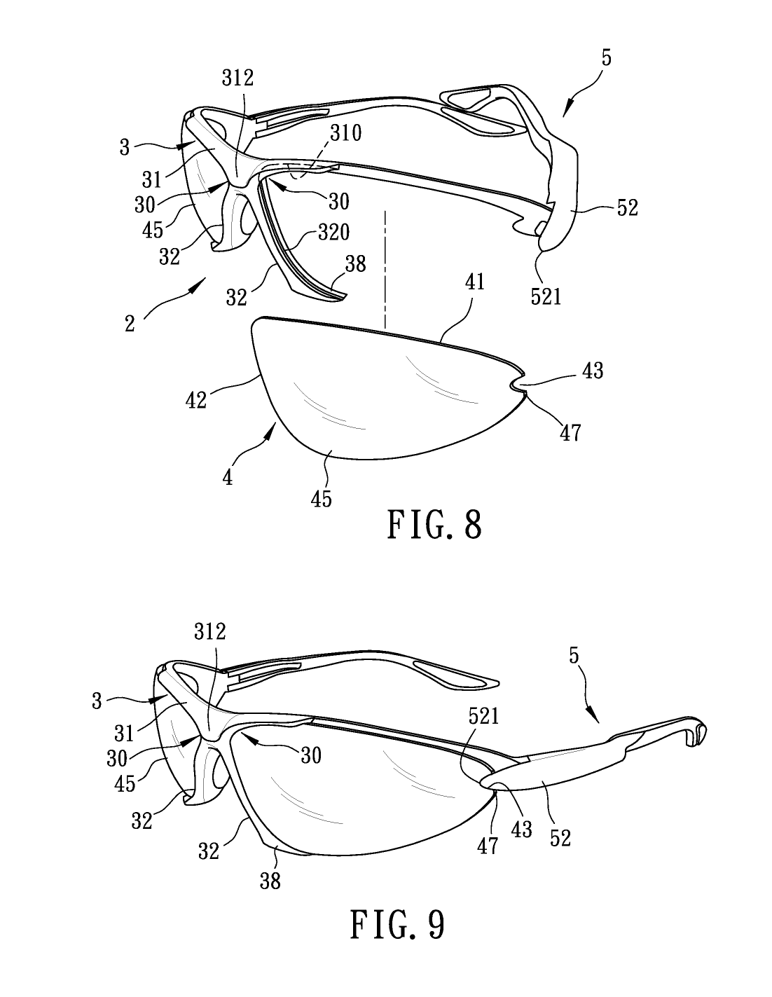

FIGS. 8 and 9 illustrate the third preferred embodiment of the eyeglass assembly 2 according to the present invention. The third preferred embodiment differs from the first embodiment in that, unlike the first segments 32 of the first embodiment which are respectively disposed at two opposite ends of the transverse segment 31, the first segments 32 of the third embodiment are disposed and join together at a middle portion 312 of the transverse segment 31. In addition, the lens unit 4 of the third preferred embodiment has a pair of lenses 45, and further has two opposite second lens edges 47. In this embodiment, the engaging recesses 43 are formed at the second lens edges 47, respectively, and the first lens edges 42, which are detachably inserted into the first grooves 320 in the first segments 32, are disposed between and spaced apart from the second lens edges 47. The first segments 32 diverge from the middle portion 312 of the transverse segment 31 so as to form a bridge structure that is adapted to be supported on the nose of a wearer. The first segments 32 cooperate with the transverse segment 31 to define the generally L-shaped structures 30, respectively, for enhancing the support of the lens unit 4. In this embodiment, the frame 3 further has two lower segments 38 extending transversely from the first segments 32, respectively, for further enhancing the support of the lens unit 4.

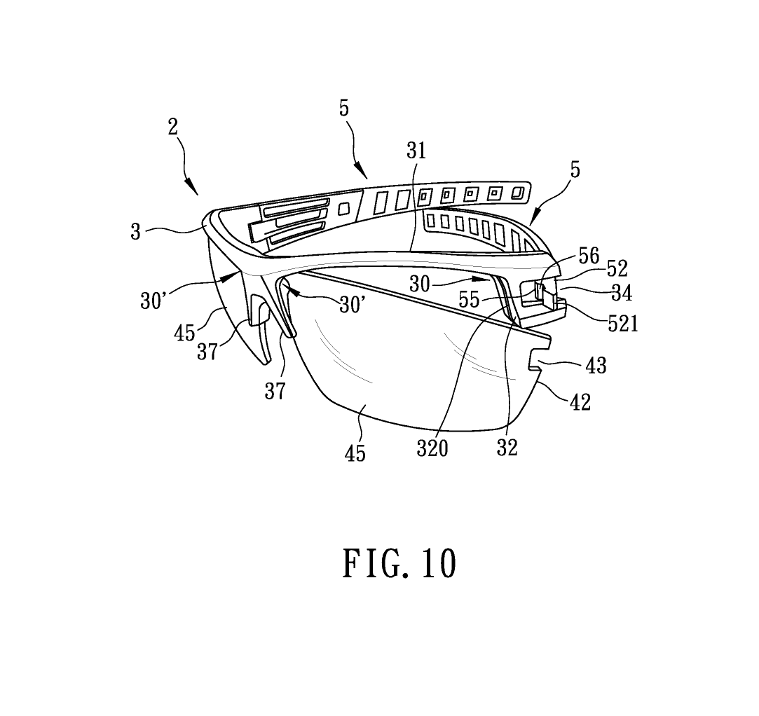

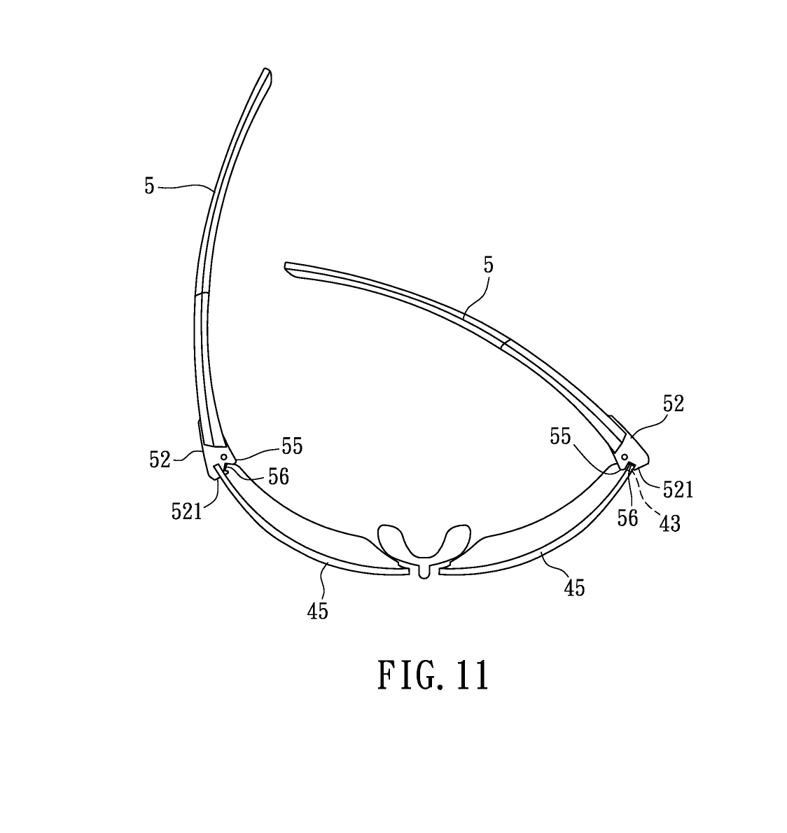

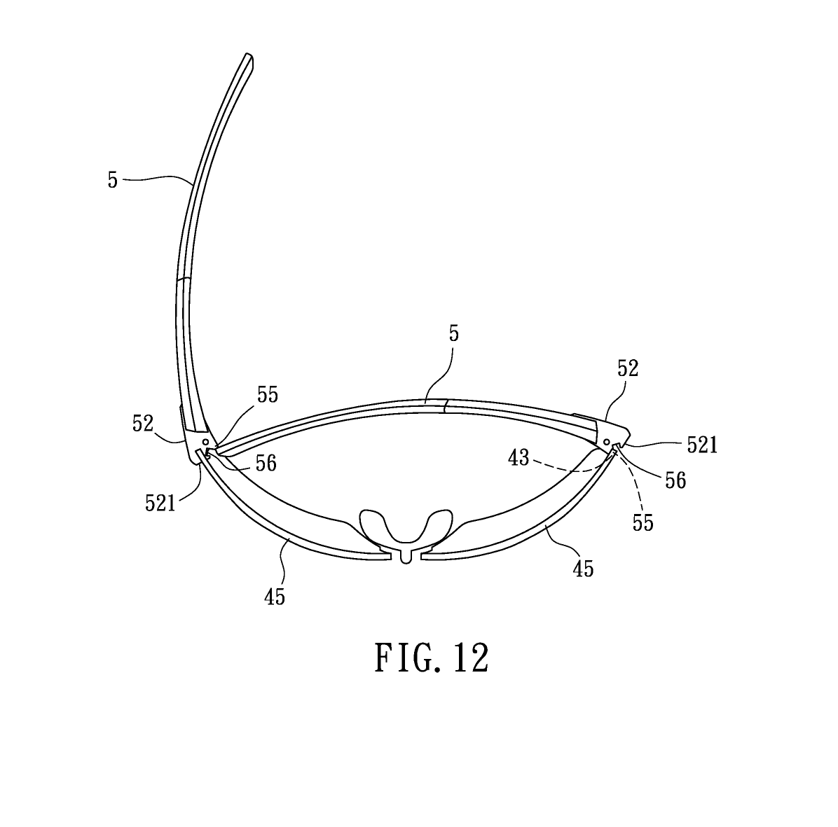

FIGS. 10 to 12 illustrate the fourth preferred embodiment of the eyeglass assembly 2 according to the present invention. The fourth preferred embodiment differs from the second embodiment in that each of the temple arms 5 further has a second engaging tongue protruding from the end portion 52, and a lens-passing notch 56 disposed between and separating the first and second engaging tongues 521, 55 from each other. In this embodiment, each of the temple arms 5 is further pivotable relative to the frame 3 to a second folded position (FIG. 11 shows one of the temple arms 5 is disposed at the second folded position (non-fully folded position) while the other is disposed at the unfolded position) between the unfolded position and the first folded position (FIG. 12 shows one of the temple arms 5 is disposed at the first folded position (fully folded position) while the other is disposed at the unfolded position). The second engaging tongue 55 of each of the temple arms 5 is disengaged from a respective one of the engaging recesses 43 when the temple arms 5 are disposed at the unfolded position, and engages the respective one of the engaging recesses 43 when the temple arms 5 are disposed at the first folded position. The first and second engaging tongues 521, 55 of each of the temple arms 5 are disengaged from the respective one of the engaging recesses 43 when the temple arms 5 are disposed at the second folded position. The lens-passing notch 56 in each of the temple arms 5 is aligned with the engaging recess 43 in a respective one of the first lens edges 42 and the first groove 320 in a respective one of the first segments 32 along a transverse direction when the temple arms 5 are disposed at the second folded position for facilitating detachment of the lens unit 4 from the frame 3.

By forming the generally L-shaped structures 30 (30′) for restricting the lens units 4 of the eyeglass assembly 2 of the present invention, the aforesaid drawback associated with the prior art can be alleviated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An eyeglass assembly comprising:
a frame having a transverse segment and two opposite first segments that extend downwardly from and cooperate with said transverse segment to form two generally L-shaped structures, respectively, said transverse segment defining a transverse groove, each of said first segments defining a first groove that is in spatial communication with said transverse groove;
a lens unit having an upper lens edge and two opposite first lens edges, and formed with two engaging recesses, said upper lens edge being detachably inserted into said transverse groove, said first lens edges being detachably and respectively inserted into said first grooves in said first segments so that said lens unit is restricted by said generally L-shaped structures; and
a pair of temple arms, each of which has an end portion that is pivoted to said frame, and a first engaging tongue protruding from said end portion;
wherein each of said temple arms is pivotable relative to said frame between an unfolded position and a first folded position, said first engaging tongue of each of said temple arms engaging a respective one of said engaging recesses when said temple arms are disposed at the unfolded position, and being disengaged from the respective one of said engaging recesses when said temple arms are disposed at the first folded position.

2. The eyeglass assembly of claim 1, wherein each of said first segments further defines a temple-receiving recess that is in spatial communication with a respective one of said first grooves, said first engaging tongue of each of said temple arms being disposed within said temple-receiving recess in a respective one of said first segments when said temple arms are disposed at the unfolded position, and protruding outwardly of said temple-receiving recess in the respective one of said first segments when said temple arms are disposed at the first folded position.

3. The eyeglass assembly of claim 2, further comprising two pivot screws, each of said temple arms being pivoted to said frame through a respective one of said pivot screws, each of said pivot screws being disposed outwardly of said temple-receiving recess in a respective one of said first segments.

4. The eyeglass assembly of claim 3, wherein each of said temple arms is a single piece.

5. The eyeglass assembly of claim 1, wherein said lens unit has the form of a mono-lens.

6. The eyeglass assembly of claim 1, wherein said engaging recesses are formed at said first lens edges, respectively.

7. The eyeglass assembly of claim 6, wherein said frame further has two second segments that extend downwardly from and join together at said transverse segment, that are disposed between said first segments, and that define two second grooves, respectively, said lens unit having a pair of lenses, and further having two second lens edges that are detachably and respectively inserted into said second grooves, respectively, said second lens edges being disposed between and spaced apart from said first lens edges.

8. The eyeglass assembly of claim 1, wherein said lens unit has a pair of lenses, and further has two opposite second lens edges, said first lens edges being disposed between and spaced apart from said second lens edges, said engaging recesses being formed at said second lens edges, respectively.

9. The eyeglass assembly of claim 1, wherein each of said temple arms further has a second engaging tongue that protrudes from said end portion, and a lens-passing notch that is disposed between said first and second engaging tongues, each of said temple arms being further pivotable relative to said frame to a second folded position between the unfolded position and the first folded position, said second engaging tongue of each of said temple arms being disengaged from a respective one of said engaging recesses when said temple arms are disposed at the unfolded position, and engaging the respective one of said engaging recesses when said temple arms are disposed at the first folded position, said first and second engaging tongues of each of said temple arms being disengaged from the respective one of said engaging recesses when said temple arms are disposed at the second folded position, said lens-passing notch in each of said temple arms being aligned with a respective one of said engaging recesses and said first groove in a respective one of said first segments along a transverse direction when said temple arms are disposed at the second folded position.
